(19) United States
(12) Patent Application Publication
(10) Pub. No.: US 2012/0268479 A1
(43) Pub. Date: Oct. 25, 2012

(54) METHODS AND APPARATUS FOR IMPROVED DITHERING ON A LINE MULTIPLIED DISPLAY

(75) Inventors: Manu Parmar, Sunnyvale, CA (US); Jennifer Lee Gille, Menlo Park, CA (US); Alan Lewis, Sunnyvale, CA (US)

(73) Assignee: QUALCOMM MEMS Technologies, Inc., San Diego, CA (US)

(21) Appl. No.: 13/279,168

(22) Filed: Oct. 21, 2011

Related U.S. Application Data
(60) Provisional application No. 61/453,012, filed on Mar. 15, 2011.

(51) Int. Cl. G09G 5/02

(52) U.S. Cl. 345/597; 345/596

(57) ABSTRACT

This disclosure provides systems, methods and apparatus including computer programs encoded on computer storage media for producing line multiplied images with better visual appearance. In one aspect, before lines of the image are multiplied, they are dithered with a noise signal that increases faster with higher frequency along the multiplied dimension of the image data than along the non multiplied dimension of the image. This results in a line multiplied image was improved image quality.

### TECHNICAL FIELD

This disclosure relates to image data processing for improving the display appearance of images that are rendered on displays that address lines simultaneously. The processing is especially suitable when used in conjunction with electromechanical display elements.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a metallic membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

One innovative aspect of the subject matter described in this disclosure can be implemented in a method of generating and displaying an image on an electronic display, including storing source image data in an electronic memory, dithering data derived from the source image data using a dither noise signal having a two dimensional frequency spectrum that is radially asymmetric around zero frequency, and displaying image data derived from the dithered image data on a display. Some embodiments may further include multiplying the lines of data derived from the dithered image data.

Another innovative aspect can be implemented in a display apparatus including a display displaying multiplied lines, wherein the multiplied lines are derived from image data dithered using a dither noise signal with a radially asymmetric frequency spectrum around zero frequency.

Another innovative aspect can be implemented in a display apparatus including an electronic memory, and an electronic processor configured to read and write to the electronic memory, and a host program configured to dither data using a dither noise signal having a two dimensional frequency spectrum that is radially asymmetric around zero frequency.

Another innovative aspect can be implemented in a display apparatus including means for storing source image data to an electronic memory, means for dithering data derived from the source image data using a dither noise signal having a two dimensional frequency spectrum that is radially asymmetric around zero frequency, and means for displaying data derived from the dithered data on an electronic display.

Another innovative aspect can be implemented in a computer readable storage medium having instructions stored thereon that cause a processing circuit to perform: storing source image data to an electronic memory, dithering data derived from the source image data using a dither noise signal having a two dimensional frequency spectrum that is radially asymmetric around zero frequency, and displaying data derived from the dithered data on a display.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

The patent or application file contains at least one drawing executed in color. Copies of this patent or patent application publication with color drawings will be provided by the Office upon request and payment of the necessary fee.

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 schematically illustrates an example array of display elements.

FIG. 10 is an example system block diagram illustrating a visual display device including a plurality of interferometric modulators.

FIG. 11 is an example of a flowchart illustrating a process for writing a portion of a frame using a line multiplying process.

FIG. 12 shows an example 12×16 array of pixel data.

FIG. 13 shows an example line doubled array derived from the array of FIG. 12.

FIG. 14 is an example system block diagram illustrating a display device including a plurality of image processing components.

FIG. 15 shows an example of a flow diagram illustrating one implementation of an image processing process.

FIG. 16 shows an example of a data flow diagram illustrating image data as it is processed by the image processing blocks of FIG. 15.

FIG. 17 shows three example noise signals and their corresponding discrete Fourier transforms used to dither images in various implementations.

FIG. 18 shows examples of a variety of images produced by different implementations of image processing components.

FIGS. 19A and 19B show examples of system block diagrams illustrating a display device 40 that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal, devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

In some display implementations, it is desired to update the displayed image at a fast rate, such as 15, 30, or 60 times per second. This is especially true when animation or video is being displayed. Because writing a line of data to a display takes a certain amount of time, a limit exists as to how fast a new image can be written. This limit will be different depending on the display technology. In some implementations, the achievable update rate is increased at the cost of reducing display resolution by simultaneously writing the same image data to two (or more) lines of the display. This essentially cuts at least in half the number of write cycles needed to write a new image to the display. In some implementations, the lines of the image are dithered before they are multiplied. Because the multiplication of the lines affects the visual results of the dithering operation, some implementations utilize a dither noise signal specifically adapted to optimize the appearance of line multiplied images.

Particular implementations of the subject matter described in this disclosure can be implemented to realize one or more of the following potential advantages. “Line doubling,” where identical image data is written to two lines of a display at once increases the achievable frame rate of a display. Dithering an image with a specialized dither noise signal before line doubling improves the visual appearance of the line multiplied, reduced resolution display. Note that line doubling is just one implementation of the more generalized technique of multi-line addressing. The subject matter described herein is equally applicable to implementations that address more than two lines of a display at once, for example, three, four, or five lines of a display, such as an IMOD display, simultaneously.

One example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

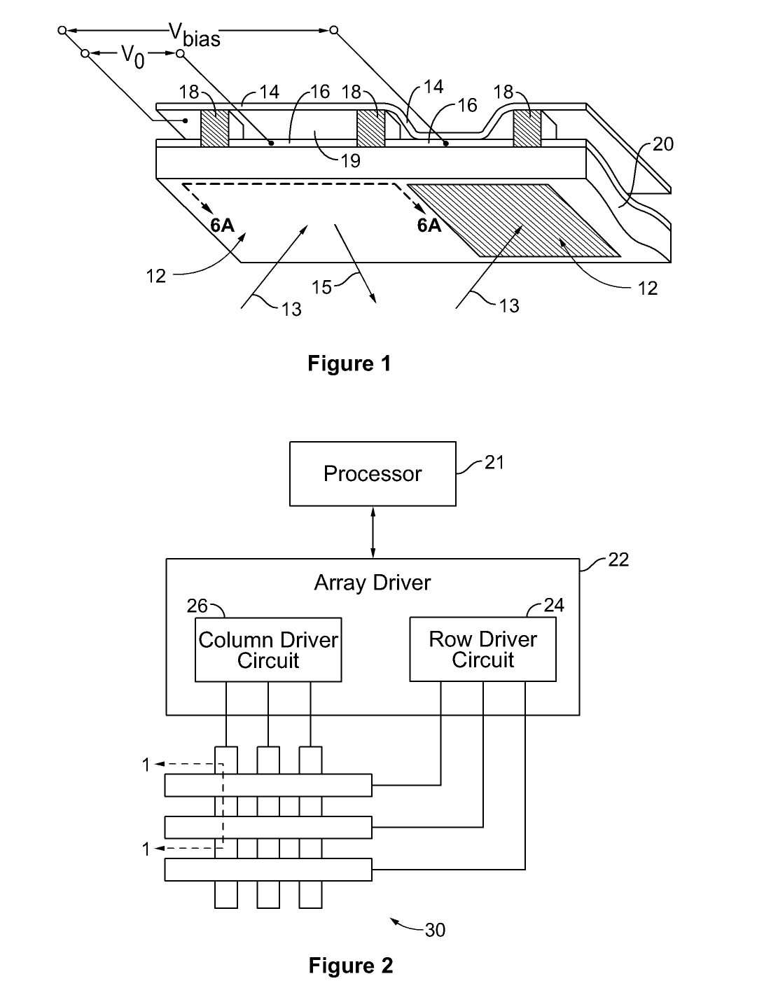

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14a remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

In alternate implementations of electronic device 30, the processor may not communicate directly with the array driver 22 as shown in FIG. 2. Instead, the processor and array driver may be connected indirectly by any one of several display connection technologies known in the art. For example, the array driver may be attached to the device 30 via an HDMI connection. Alternatively other technologies such as 1394 “Firewire”, USB, DVI, or VGA may be employed. In these implementations, processor 21 generates a display signal over the display connection to communicate with array driver 22.

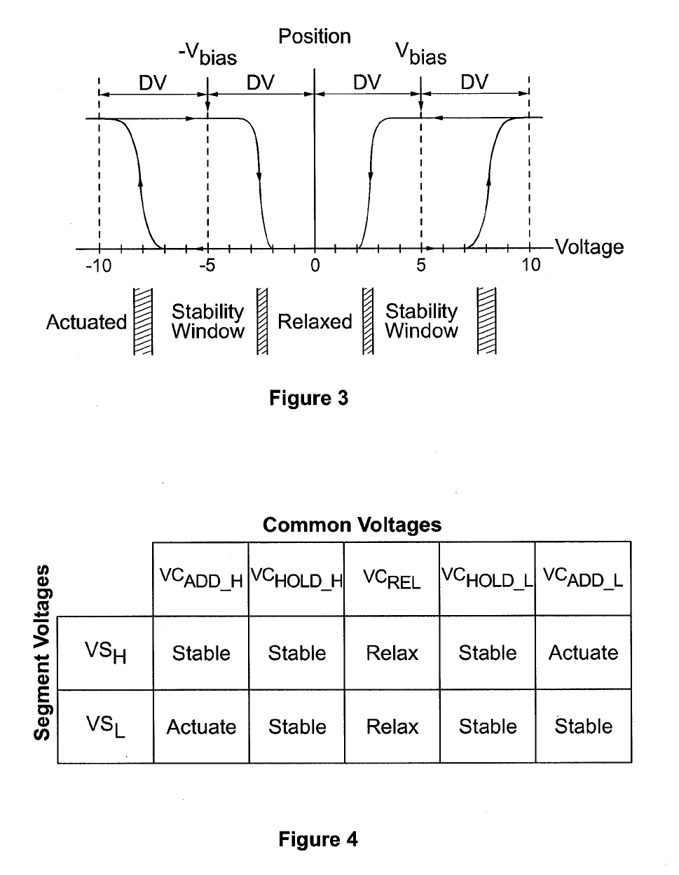

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

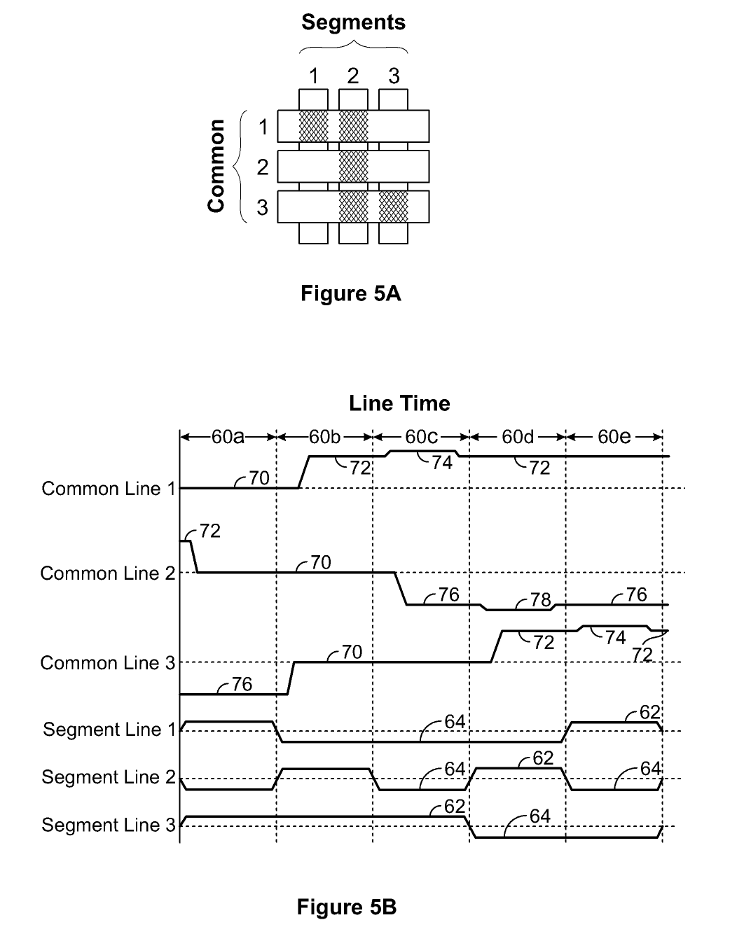

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{^{—}}_{H} or a low hold voltage VC_{HOLD}_{^{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{^{—}}_{H} or a low addressing voltage VC_{ADD}_{^{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{^{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{^{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{^{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

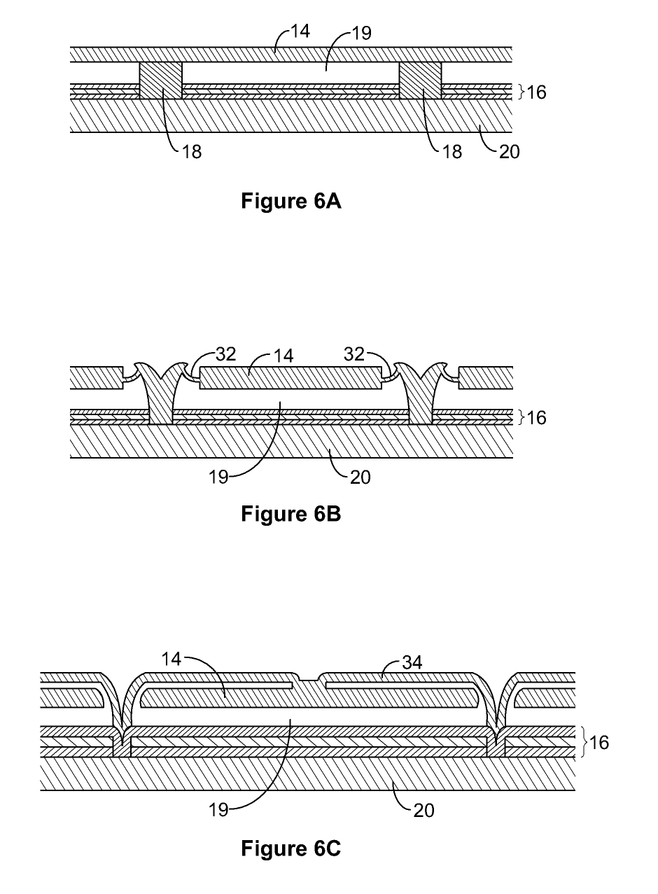

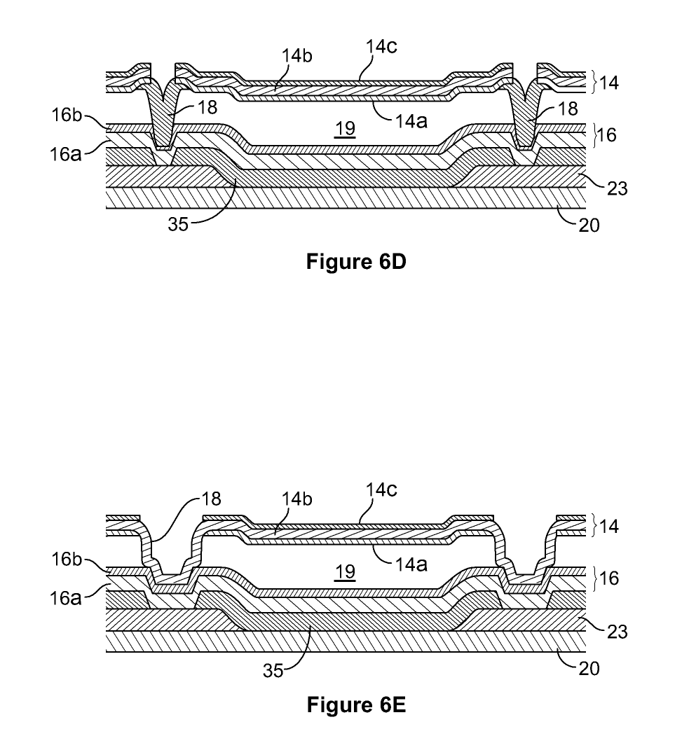

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an Al alloy with about 0.5% Cu, or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, CF₄ and/or O₂ for the MoCr and SiO₂ layers and Cl₂ and/or BCl₃ for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

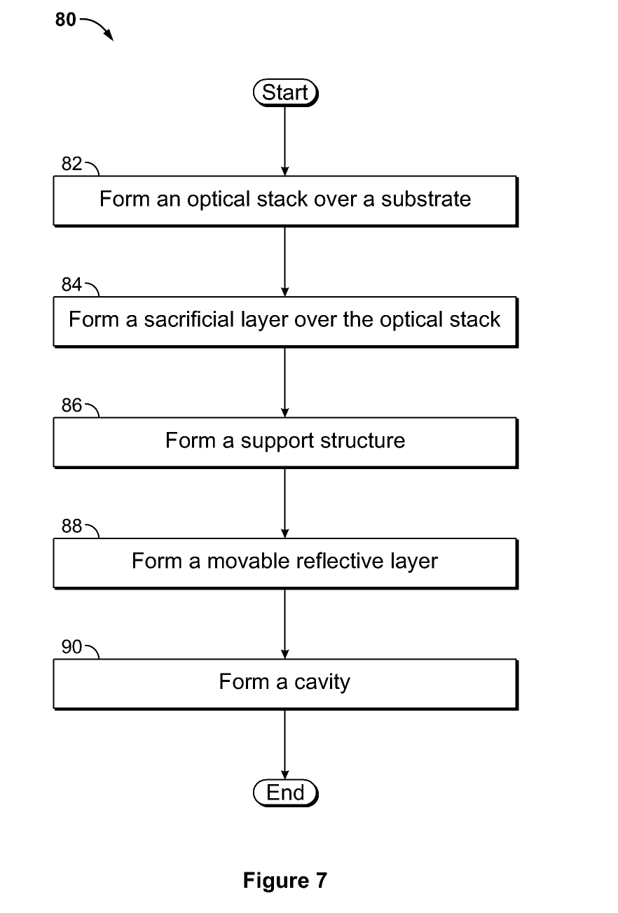

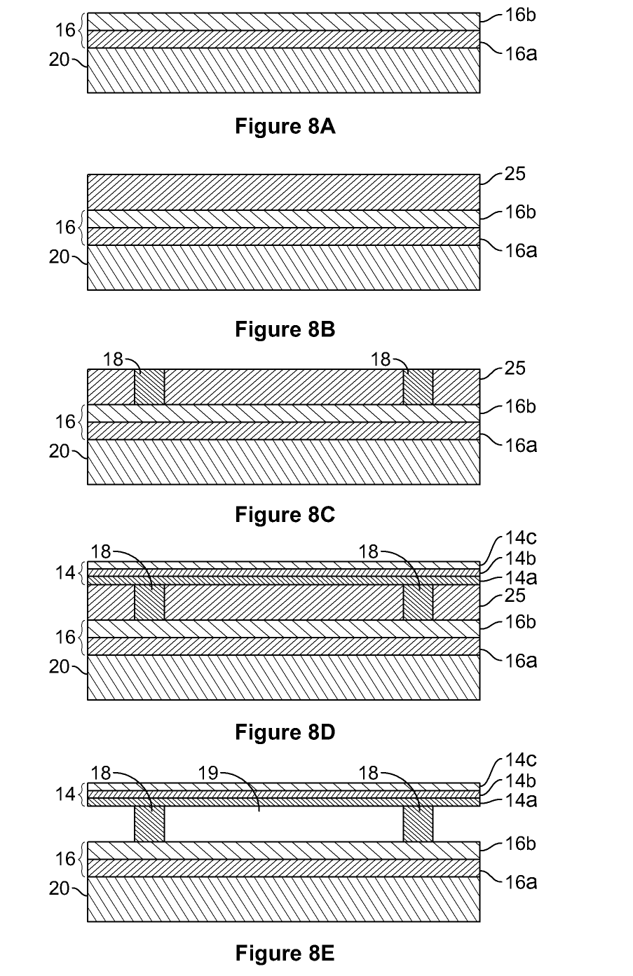

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity. 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

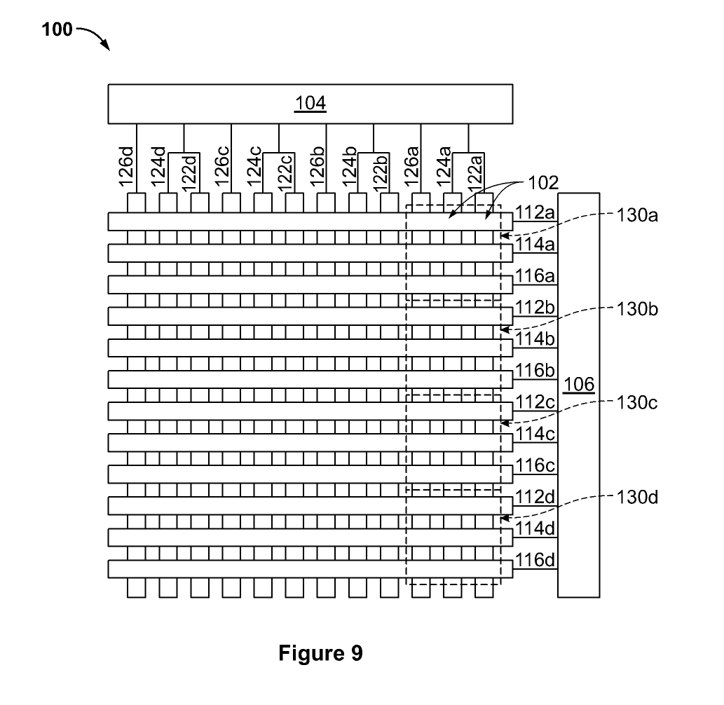

FIG. 9 schematically illustrates an example array 100 of display elements 102. The array 100 can include a plurality of electromechanical display elements 102, which in some implementations may include interferometric modulators. A plurality of segment electrodes or segment lines 122a-d (collectively referenced as 122), 124a-d (collectively referenced as 124), 126a-d (collectively referenced as 126) and a plurality of common electrodes or common lines 112a-d (collectively referenced as 112), 114a-d (collectively referenced as 114), 116a-d (collectively referenced as 116) can be used to address the display elements 102, as each display element will be in electrical communication with a segment electrode and a common electrode. Segment driver circuitry 104 is configured to apply desired voltage waveforms across each of the segment electrodes, and common driver circuitry 106 is configured to apply desired voltage waveforms across each of the column electrodes. In some implementations, some of the electrodes may be in electrical communication with one another, such as segment electrodes 124a and 122a, such that the same voltage waveform can be simultaneously applied across each of the segment electrodes.

Still with reference to FIG. 9, in an implementation in which the display 100 includes a color display or a monochrome grayscale display, the individual electromechanical elements 102 may include sub-pixels of larger pixels, wherein the pixels include some number of sub-pixels. In an implementation in which the array includes a color display including a plurality of interferometric modulators, the various colors may be aligned along common lines, such that substantially all of the display elements along a given common line include display elements configured to display the same color. Some implementations of color displays include alternating lines of red, green, and blue sub-pixels. For example, lines 112 may correspond to lines of red interferometric modulators, lines 114 may correspond to lines of green interferometric modulators, and lines 116 may correspond to lines of blue interferometric modulators. In one implementation, each 3x3 array of interferometric modulators 102 forms a pixel such as pixels 130a-130d. In the illustrated implementation in which two of the segment electrodes are shorted to one another, such a 3×3 pixel will be capable of rendering 64 different colors (e.g., a 6-bit color depth), because each set of three common color sub-pixels in each pixel can be placed in four different states (within a common color the four states are: off, one sub-pixel (or element 102, for example) on, two sub-pixels on, and three sub-pixels on). When using this arrangement in a monochrome grayscale mode, the state of the three sub-pixel sets for each color are made to be identical, in which case each pixel can take on four different gray level intensities. It will be appreciated that this is just one example, and that larger groups of interferometric modulators may be used to form pixels having a greater color range at the cost of overall pixel count or resolution.

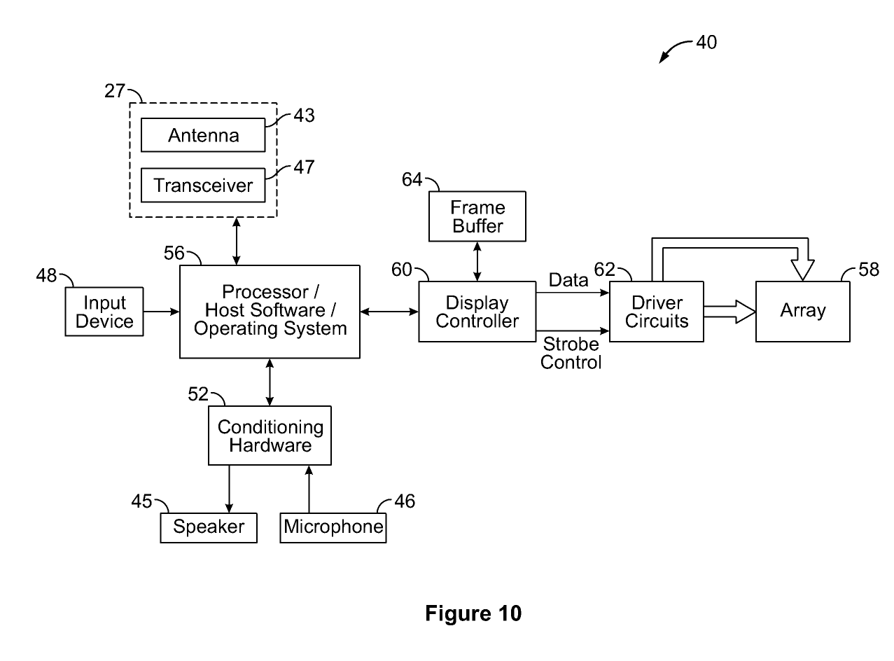

FIG. 10 is an example system block diagram illustrating a visual display device 40 including a plurality of interferometric modulators. The display device 40 can be, for example, a cellular or mobile telephone. However, the same components or slight variations thereof are also illustrative of various other types of display devices such as televisions, laptop or notebook computers, and portable media players.

The device will typically include host software such as an operating system and one or more application programs that are running on the one or more processors 56 in the device. These host programs define what is to be displayed on the array 58. The processor 56 will generally include an internal memory (not shown) for storing image data, and includes electronic processing circuitry configured to process this image data as defined by one or more software or firmware programs running on the processor 56. In alternate implementations, the memory may be a physically separate component from the processor 56.

In some implementations, the host software configures the processor to perform a variety of image processing blocks. For example, the host processor may configure the processor to store image data to the internal or external memory (not shown) of the device 40. When utilizing external memory, the processor will be in communication with the external memory via an address and data bus (also not shown). A processor with internal memory or a processor in communication with an external memory, along with host software running on processor 56 represents one means for storing image data to an electronic memory.

The host software may also configure the processor to perform other image processing blocks, for example, dithering, quantization, and line multiplying blocks discussed later. In some implementations, the host software further configures the processor to communicate with the display controller 60 to determine what specific image data is displayed. The host software may also control line multiplying of the image data before the data is transferred to display controller 60. In other implementations, display controller 60 may control line multiplying.

Although the host software determines what information is displayed, direct control over the pixels of the array is generally allocated to a display controller 60 and driver circuits 62. Although illustrated as two blocks in FIG. 10, these two functions are often part of one controller integrated circuit, as is shown, for example, in FIG. 2. As described above, the driver circuits 62 generate and apply the segment and common waveforms of, for example, FIG. 5A, in accordance with the display data and line strobe timing required to place the pixels of the array in the state desired by the host software.

As the host receives and/or generates pixel data for display, it stores that data in a frame buffer 64. The host may have direct access to these memory locations, or it may access them through the display controller 60. The frame buffer 64 may be incorporated into the display controller 60. The display controller 60 reads the memory locations that constitute the frame buffer, and places the data into the correct format and timing to operate the driver circuits 62.

As noted above, in some displays, the time required to write data to the display elements can place constraints on the overall rate at which the display can be written to. If each common line is separately addressed, the write time necessary for each line will determine the overall frame write time. In some implementations, an increased refresh rate or frame rate of the display may be desired, and may be more important than the resolution or color range of the display for a good visual appearance to a user. In some implementations, driver circuitry and display arrays which are capable of presenting high resolution images with a wide color range may be utilized in a variety of different “modes” of strobing the common lines of the array. These modes may be designed to reduce one or both of the resolution and the color range and in turn increase the potential refresh rate of the display and/or save power consumption by strobing multiple lines of the array at the same time.

Referring back to FIG. 9, in some implementations, the resolution can be effectively reduced by simultaneously applying the same waveforms across common lines corresponding to display elements of the same color. For example, if a write waveform is simultaneously applied across red common lines 112a and 112b to address those common lines, the data pattern written to the interferometric modulators along common line 112a will be identical to the data pattern written to the interferometric modulators along common line 112b. If write waveforms are simultaneously applied across green common lines 114a and 114b, and then across blue common lines 116a and 116b, the data pattern written to pixel 130a will be identical to the data pattern written to pixel 130b, causing pixel 130a to display the same color as pixel 130b. Although the term “simultaneously” is used throughout this discussion for the purposes of conciseness, the voltage waveforms need not be perfectly synchronized. As discussed above with respect to FIG. 5B, the write waveform may include an overdrive or address voltage during which the potential difference across a display element is sufficient to result in data being written to that display element given an appropriate segment voltage. So long as there is sufficient overlap between the overdrive or address voltages of the write waveforms applied across the common lines and the data signals applied across the segment lines that actuation of the display elements on all of the addressed common lines will occur, the write waveforms and data signals are considered to be applied simultaneously.

In comparison to a write process in which each common line is individually addressed, data has been written to pixels 130a and 130b in as little as half the time it would have taken to write separate data to pixels 130a and 130b, at the cost of decreased resolution. If this line multiplying process is applied to the remainder of the common lines in the display, the frame write time is considerably reduced.

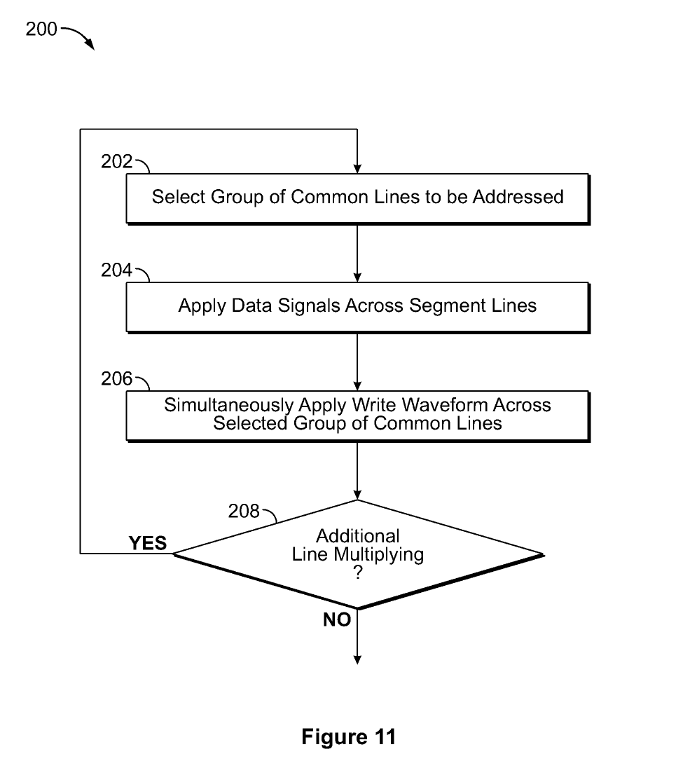

FIG. 11 is an example of a flowchart illustrating a frame write process 200 which reduces the overall frame write time through the use of line multiplication. This particular frame write process may represent only a portion of the complete frame write, and may occur at the beginning, middle, or end of the complete frame write. Thus, image data may already have been written to one or more common lines within the frame. In block 202, a pair or group of common lines to be simultaneously addressed is identified.

In block 204, a plurality of data signals are applied along segment lines. Simultaneously, in block 206 a first write waveform is simultaneously applied to at least two common lines in the array to address the waveforms. Such a write waveform may include, for example, a positive or negative overdrive or address voltage appropriate for the common lines being addressed, as described with respect to FIG. 5B above. Hold voltages may be simultaneously applied to multiple common lines not being addressed, and reset voltages may be applied to common lines prior to addressing the common lines. When the write waveform is applied along a pair or group of common lines to be addressed, the application of properly selected data signals along the segment lines will not result in an accidental actuation or accidental release of display elements along common lines not being addressed.

Although the flowchart of FIG. 11 illustrates block 204 as taking place before block 206, the desired actuation will occur so long as there is sufficient overlap between the write waveform and the plurality of data signals to allow all the electromechanical devices sufficient time to actuate or release in accordance with the applied data signals. The frame write time can thus be reduced by maximizing the overlap between the write waveform of block 206 and the data signals of block 204, and block 204 and 206 can occur in either order so long as there is overlap between the application of the signals.

In block 208, a determination is made as to whether any additional pairs or groups of common lines are to be simultaneously addressed. If so, the process returns to block 202 to select an appropriate pair or group of common lines to simultaneously address. If not, the process moves to further blocks which could include a termination of the frame write process if all necessary common lines have been addressed, or could include individual addressing of certain common lines. In addition, simultaneous addressing of pairs or groups of common lines may be interspersed with individual addressing of common lines, depending on the nature of the data to be written. For example, if a portion of the image data written to a display includes text or another still image, and another portion of the data includes a video which can be displayed at a lower resolution and which is located vertically between sections of text or still image, the portions of the display located above the video can be written by individually addressing those common lines, the portions of the display including the video can be written at a lower resolution by utilizing a line multiplying write process, and the write process may return to individual addressing of the common lines of the display for the portion of the display located below the video.

The particular method of line multiplication discussed above can apply identical write waveforms to common lines in adjacent pixels, although other pairs of common lines may be simultaneously addressed in other implementations. Furthermore, even if the line multiplying method is used to simultaneously apply write waveforms to common lines in adjacent pixels, all of the lines in a given pair or group of pixels need not be written before writing lines in other groups of pixels. In some implementations, multiple pairs or groups of common lines of the same color can be addressed before addressing common lines of another color. For example, referring again to FIG. 9, red common lines 112a and 112b may be simultaneously addressed, followed by a subsequent write process which simultaneously addresses red common lines 112c and 112d. Because different voltage waveforms may be used to address common lines of different color display elements, the system may utilize the write waveform appropriate for a particular color for multiple pairs or groups of common lines before addressing common lines of another color. In some implementations, any number of pairs or groups of common lines of a given color may be addressed before addressing common lines of another color. For example, in some implementations 5 pairs or groups of common lines of a given color may be addressed before common lines of another color are addressed, although larger or smaller numbers of pairs or groups may be used, as well.

In addition, although the simultaneous application of substantially identical waveforms to two common lines is discussed herein, further increases in refresh rate or frame write or reductions in power usage may be achieved by simultaneously applying substantially identical waveforms to more than two common lines.

In some methods of updating data on a display, charge buildup on particular display elements may be reduced by altering the polarity of the write waveforms applied to the common line. In one implementation, which may be referred to as frame inversion, a given frame is fully addressed using write waveforms of a particular polarity, and a subsequent frame is fully addressed using write waveforms of the opposite polarity. In other implementations, however, the polarity of write waveforms may be altered during a single frame write. In another implementation, which may be referred to as line inversion, the polarity of the write may be altered after addressing each line, and the polarity used to address a particular line will be changed in subsequent frames. If the display is being updated in a substantially linear fashion, this may result in adjacent lines being addressed by write voltages having opposite polarities. Thus, in some implementations, it may be advantageous to utilize a given write waveform having a given polarity to write to, for example, every other red common line with a positive polarity for some number of common lines, before writing to the skipped red common lines with a negative polarity.

Polarity inversion within a frame can be applied to a write process in which line multiplying is used as well. In one implementation, red lines 112c and 112d may be addressed using the opposite polarity of that used to address red lines 112a and 112b within a given frame write. In an implementation, such as the one described above, where a write waveform with a given polarity is used for multiple sequential addressing operations, red lines 112a and 112b may be addressed using a first polarity, and red lines 112c and 112d may be skipped while some number of additional pairs or groups of red lines are written using the first polarity. After some number of pairs or groups have been addressed using the first polarity, red lines 112c and 112d may be addressed using the opposite polarity.

If polarity inversion is utilized, addressing a certain number of lines of one color using a first polarity need not be followed by addressing a certain number of lines in the same color using the opposite polarity. In some other implementations, positive read/write processes may be followed by, for example, negative blue write processes, or positive green write processes.

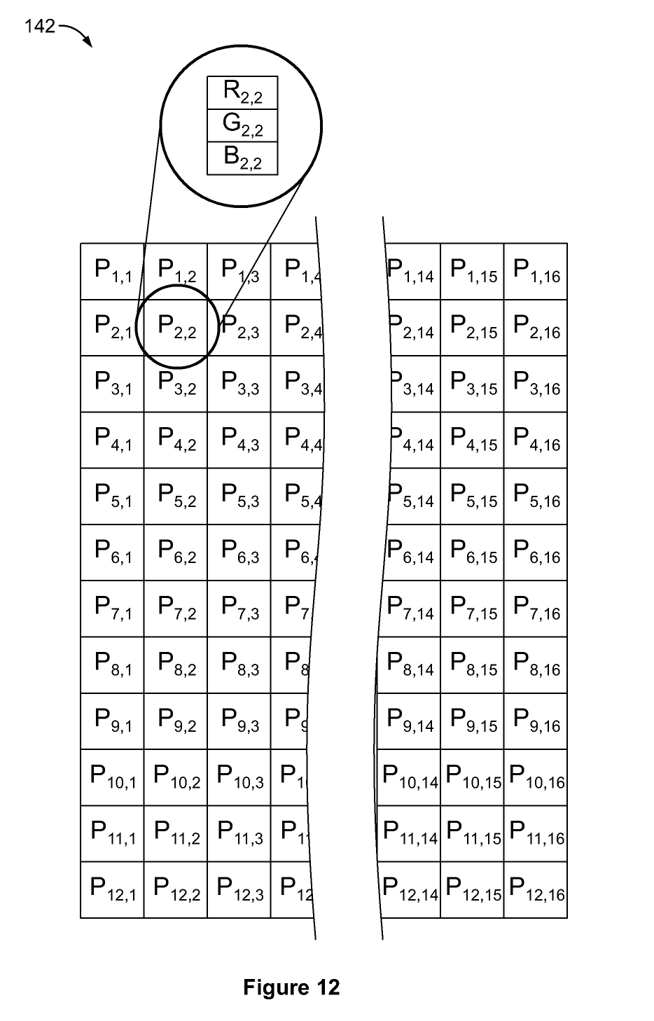

The above description sets forth the methods and benefits of writing identical data to multiple common lines simultaneously. Turning now to FIGS. 12-18, methods of processing image data to produce the multiplied lines will be described.

FIG. 12 illustrates an example 12×16 array of pixel data. The image data 142 can be arranged as a row-column array of pixel data, with each element of pixel data designated P_{row,column} at each location in the array. In this example, there are 12 rows and 16 columns of pixel data. Of course, in an actual display more rows and columns will generally be provided, with 768 rows of pixels and 1024 columns of pixels being one common implementation. Each pixel data element P may be formed of three different color sub-pixel data elements, which may include red, green, and blue sub-pixel data elements. Thus, as shown in FIG. 12, pixel data P_{2,2} is made up of red sub-pixel data R_{2,2}, green sub-pixel data G_{2,2}, and blue sub-pixel data B_{2,2}. A display device that displays this image will therefore have 12 rows of red display elements, 12 rows of green display elements, and 12 rows of blue display elements interleaved with each other. This is the same format as shown in the physical display of FIG. 9, where each row of pixels includes three “sub-rows,” one of each color. The pixel data at each location may have any number of tone-levels, e.g., 2 bits per color, 4 bits per color, 6 bits per color, 8 bits per color, or any other value.

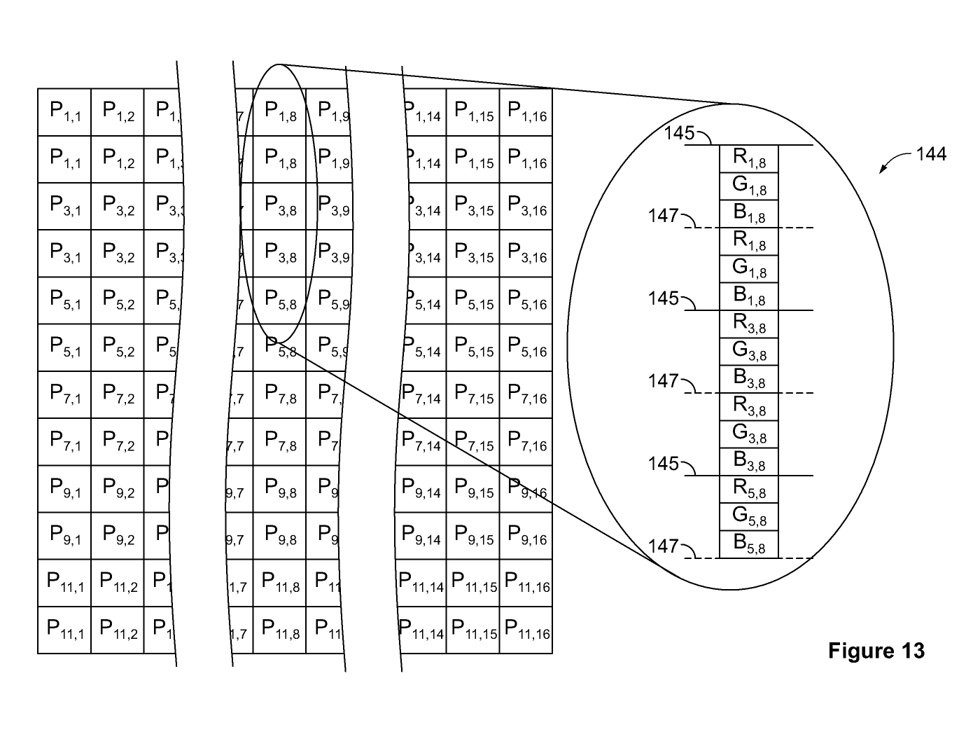

One implementation for creating doubled lines is to substitute the even rows of data with copies of the odds row of data. FIG. 13 illustrates an example line multiplied array derived from the array of FIG. 12. In FIG. 13, the six odd rows of pixel data from FIG. 12 are used to fill the entire twelve rows of image data. Row 1 data is used in both row 1 and row 2, row 3 data is used in both row 3 and row 4, etc. A person having ordinary skill in the art will readily appreciate that the original odd rows of data could be substituted with copies of the even rows of data instead. Another implementation is to average the data of adjacent common color rows, and use that data for both of the rows that were averaged together. In this case, rows 1 and 2 would each contain the average of original rows 1 and 2. As discussed above, this line doubling enables the application of simultaneous waveforms across multiple common lines, thus increasing the maximum possible refresh rate or frame rate.

Further shown in FIG. 13 is an expanded portion 144 of several pixels, showing the red, green, and blue sub-pixel values. In the expanded view 144 of five pixels of the array, the pixel boundaries are marked with solid lines 145 and dashed lines 147 for purposes of illustration. For the illustrated set of pixels, the data for all three colors is copied above and below each dashed line. The image data changes across solid line pixel boundaries. Thus, the line doubling essentially turns the original square pixels into rectangular pixels with a long side extending between the solid lines 145 in the direction of the doubling. Because of this loss of resolution in the line multiplied image of FIG. 13, visual artifacts are created, especially near the edges of objects in the image where brightness transitions occur. Display of text is especially susceptible to visual artifacts caused by line doubling in this manner.

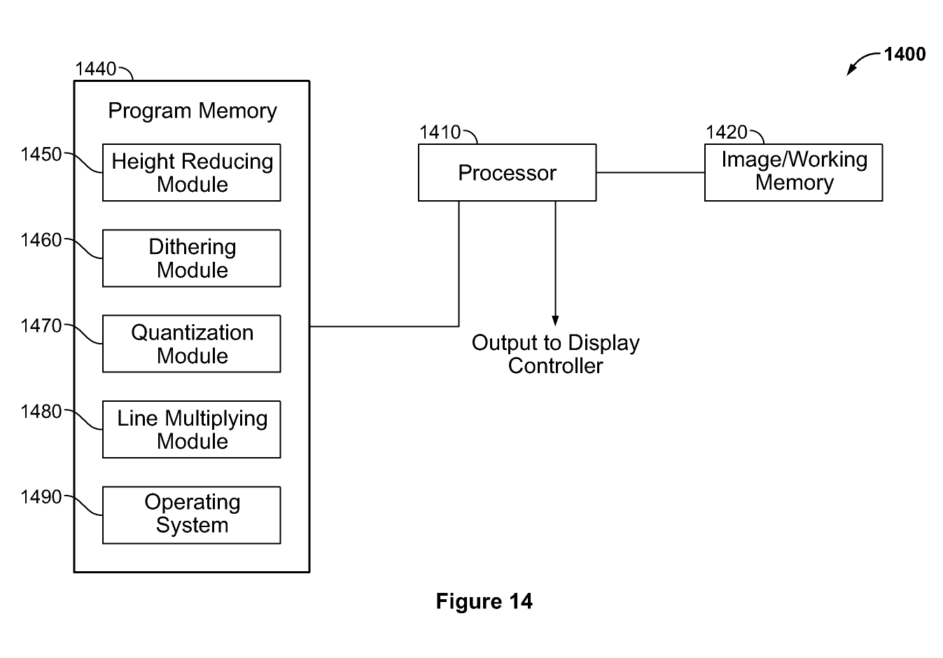

Digital imaging techniques may be employed to mitigate or eliminate the adverse effects of line doubling. These techniques may be implemented by host software executing, for example, on processor 56 of FIG. 10, or similarly on processor 21 of FIG. 2. FIG. 14 is an example system block diagram illustrating a display device including a plurality of image processing components. Processor 1410 of device 1400 is connected to working memory 1420 and program memory 1440. Program memory 1440 stores host software including multiple image processing modules and an operating system as shown. The host software image processing modules implement digital processing techniques that may improve the quality of a display utilizing line doubling.

Modules stored in program memory 1440 include height reducing module 1450, dithering module 1460, quantization module 1470, and line multiplying module 1480. These image processing modules 1440, 1459, 1460, and 1470 include instructions that configure the processor 1410 to perform digital imaging tasks. These tasks may include reducing a full height image to a reduced height image, dithering of the reduced height image, quantizing the dithered image, and line doubling the quantized image. Instructions in the image processing modules may also configure the processor to read and write the working memory 1420 to store and load image data as it is processed through the various blocks of a digital image pipeline.

Processor 1410 also executes instructions contained in operating system module 1490 to manage the hardware and software resources of device 1400. Instructions in operating system module 1490 may also provide a consistent interface to the instructions in the digital imaging modules and therefore simplify their implementation. Processor 1410 is also connected to display control hardware, as illustrated by display controller 60 of device 40 of FIG. 10.

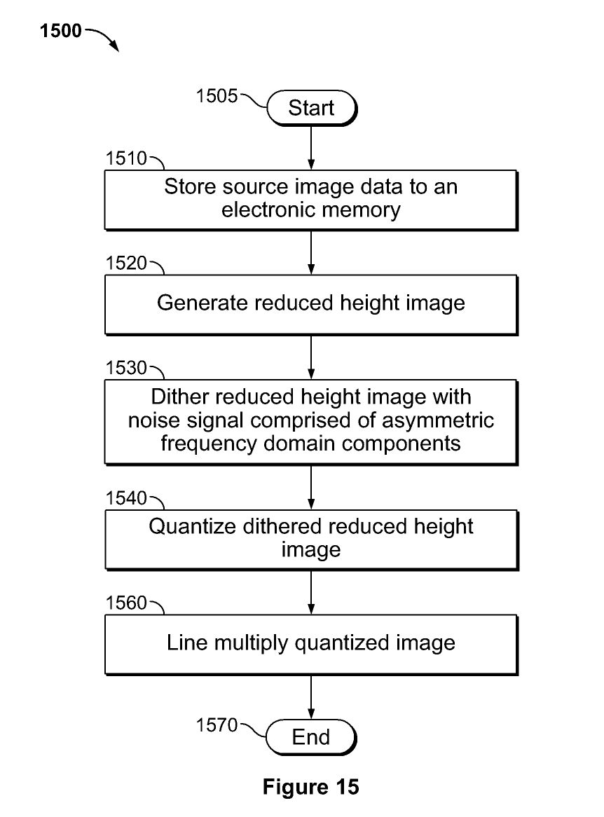

FIG. 15 shows an example of a flow diagram illustrating one implementation of an image processing process. FIG. 15 may be implemented by instructions within the image processing modules of FIG. 14, to include the height reducing module 1450, dithering module 1460, quantization module 1470, or the line multiplying module 1480. Process 1500 begins at start block 1505 and then moves to block 1510 where instructions implementing block 1510 cause a source image to be stored to an electronic memory. In some implementations, the electronic memory may include the working memory 1420 of FIG. 14.

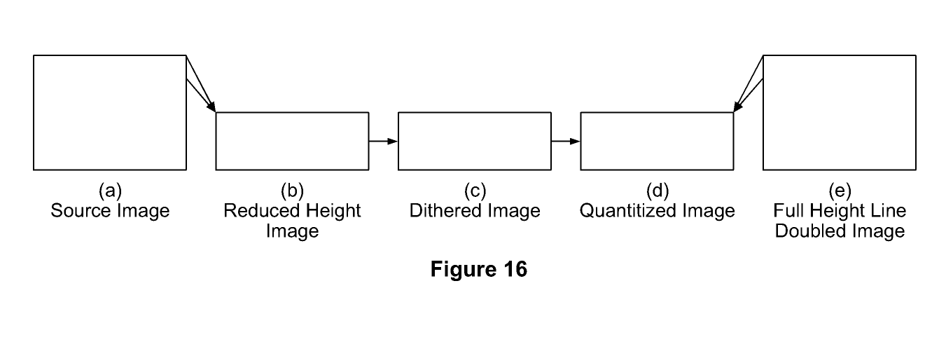

FIG. 16 shows an example of a data flow diagram illustrating image data as it is processed by the image processing blocks of FIG. 15. Source image (a) of FIG. 16 illustrates a source image that may be stored to a memory in block 1510 of FIG. 15.

Returning to FIG. 15, after block 1510 completes, process 1500 then moves to block 1520 where a reduced height image is generated. In one implementation, the reduced height image may be generated by instructions in the height reducing module 1450 of FIG. 14. This process is also illustrated in FIG. 16 by the arrow from the source image (a) to reduced height image (b). As described above, adjacent lines of the source image may be averaged to produce one line of the reduced height image (b). Alternatively, in other implementations, alternate lines of the source image may be copied to form the reduced height image, with the remaining lines simply omitted.

Next, process 1500 moves to block 1530 where the reduced height image is dithered. The dithering may be performed in one implementation by the instructions of dithering module 1460 of FIG. 14. The dithered image is also illustrated by image (c) of FIG. 16, which is derived from reduced height image (b).

Dithering improves image quality by adding noise to the image that disrupts the visual patterns that would otherwise result from the quantization error caused when similarly valued pixels are rounded during the quantization process (described below). The noise signal used by the host program in a dithering process can be represented by a dither mask. In one implementation, to apply the noise signal to the target image, instructions in the host program “tile” the dither mask onto the target image. In at least one implementation, the tiling process is performed by instructions in the dithering module 1460 of device 1400. Each element of the tiled dither mask is then added to a corresponding element of the target image.

As explained further below, the characteristics of the noise signal effect the quality of the resulting image. In some image processing implementations, it becomes advantageous to tailor the frequency components of the dither noise signal to best optimize the quality of the final image. In line doubling image processing implementations, a noise signal with a two dimensional frequency spectrum that is radially asymmetric around zero frequency may be used.

Next, process 1500 moves to block 1540 where the dithered image is quantized. Quantization of the reduced height image may be performed in one implementation by the instructions of quantization module 1470 of FIG. 14. The quantized image is also illustrated by image (d) of FIG. 16. Quantization may be performed in some implementations to adapt the color depth of the source image data to a color depth supported by the target display. For example, some implementations of the IMOD displays render two bits per sub-pixel of color information, corresponding to 64 total colors. However, the source image may include 24 bits of color information, typically arranged as eight bits per color per pixel. When the electronic display's color depth is lower than a source image data's color depth, the host software's image processing utilizes a quantization process to convert the color depth of the source image to one compatible with the target display.

Process 1500 then moves to block 1560 where the quantized image is line multiplied. Line multiplying may be performed in one implementation by instructions contained in the line multiplying module 1480 of FIG. 14. Line multiplying may include writing the data directly to an electronic display, as may be performed by the device 40 illustrated by FIG. 10. A line multiplied image is also illustrated by image (e) of FIG. 16. Process 1500 then moves to end state 1570.

While the illustrated embodiment of FIG. 15 performs blocks 1520-1560 only once, some implementations may perform blocks 1520-1560 separately for each color plane of the target image. In these implementations, the same noise mask may be used for each color plane. In this case, all sub pixels comprising a single pixel may be modified by the same noise value. Alternatively, different noise masks may be used for each color plane. In these implementations, the sub pixels of a single pixel may be modified by distinct noise values taken from the different noise masks.

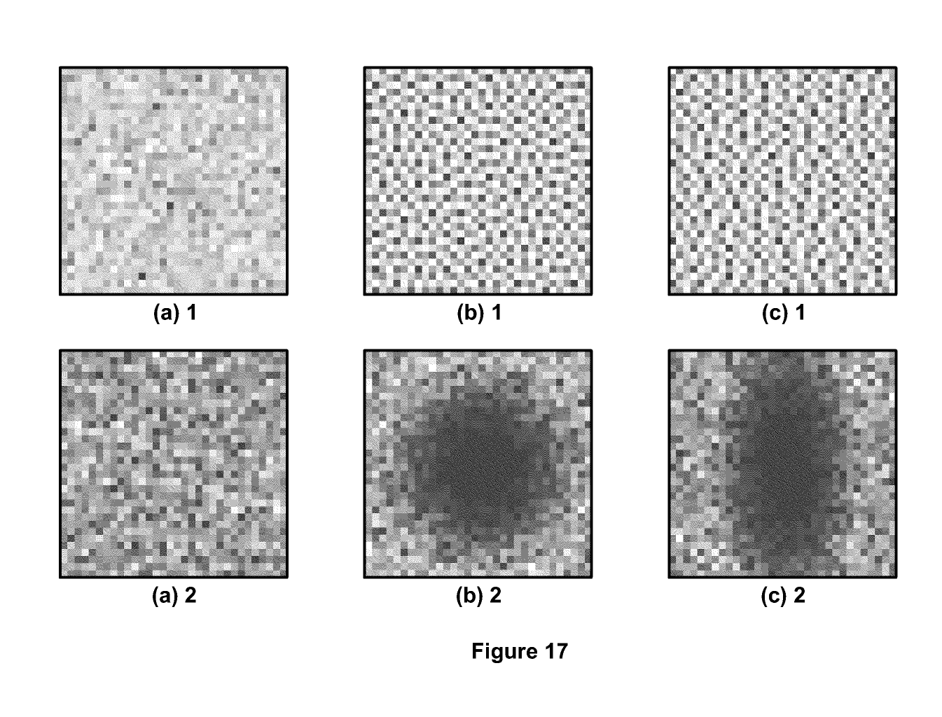

FIG. 17 shows three example noise signals and their corresponding discrete Fourier transforms used to dither images in various implementations. The top row of masks, labeled (a)(1), (b)(1), and (c)(1), illustrate three noise masks that may be used to dither images. These masks have a noise value at each position in the mask. The shading of each square in the noise mask indicates the amplitude of the noise value at that position in the mask, with lighter shading denoting a larger value. The dithering process first tiles the noise mask on the image being dithered. Then, the dithering process adds the noise value at each position in the tiled mask to the value of the corresponding pixel in the image being dithered, with the result overwriting the pixel value in the target image.

Below each noise mask in the top row of FIG. 17 is a graphical representation of the discrete Fourier transform of the mask's noise signal, illustrating the distribution of frequency components of the noise mask around zero frequency. FIG. 17, image (a)(2) illustrates the discrete Fourier transform of the noise signal shown in image (a)(1), consisting of white noise. As shown, the large and small frequency component amplitudes for the noise mask of FIG. 17(a)(1) are distributed across the two dimensional frequency spectrum.

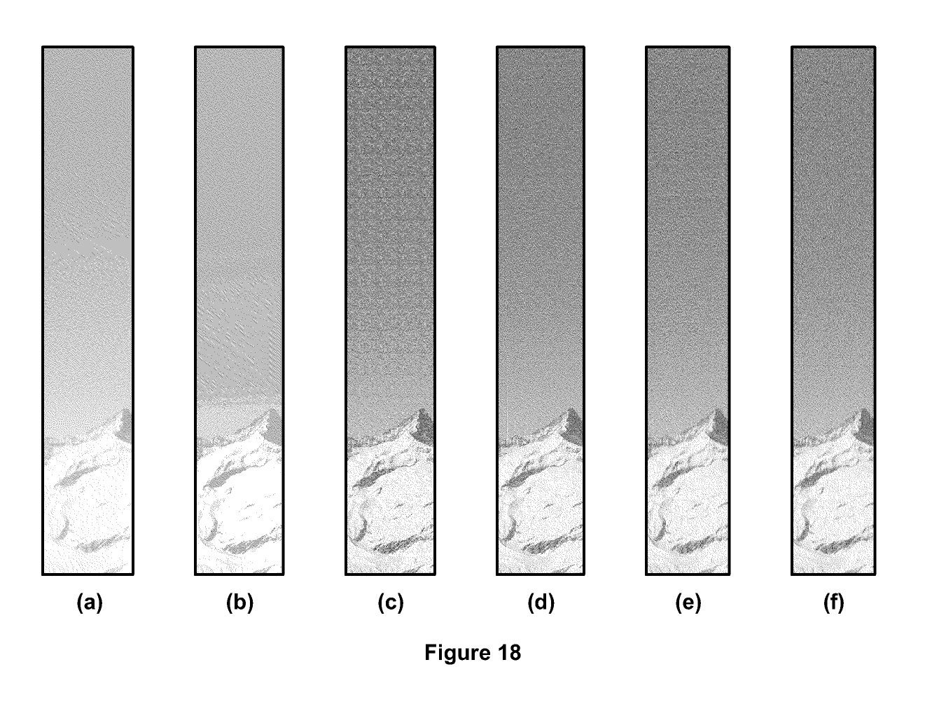

FIG. 18 shows examples of a variety of images produced by different implementations of image processing components. Image (a) represents an original source image, while image (b) shows the image after a quantization process without any dithering performed on the image beforehand. The banding effects are created by quantization error, which arises when adjacent pixels with similar values are mapped to an identical new pixel value.

Utilization of the noise signal represented by FIG. 17, image (a)(1) to dither an image prior to quantization results in a visual appearance similar to that shown in FIG. 18(c). While the banding caused by quantization errors has been eliminated, use of the white noise signal of FIG. 17 image (a)(1) results in image artifacts caused by the low frequency components of the noise signal. This is especially noticeable in the sky portion of the image.

By utilizing a noise signal with primarily high frequency components, the artifacts evident in FIG. 18, image (c) can be reduced. FIG. 17, image (b)(1) is a noise signal including primarily high frequency components. This is illustrated by its discrete Fourier transform, image (b)(2). The dark region in the center of image (b)(2) illustrates the low amplitude of low frequency components around zero frequency in the noise mask of FIG. 17(b)(1).

Applying the noise signal of FIG. 17, image (b)(1) to the image of FIG. 18(a) prior to quantization results in an improvement compared to FIG. 18, image (c), which utilized the white noise signal of FIG. 17, image (a)(1). These results can be seen in FIG. 18(d). Dithering with high frequency noise achieves these results by taking advantage of characteristics of the human visual system. The human visual system is less sensitive to high frequency noise than low frequency noise. By dithering with high frequency noise, the visual artifacts introduced by the quantization process in pushed into the higher frequencies, where the human visual system is less sensitive.

However, in implementations using image processing that performs dithering and line multiplying, as illustrated by process 1500 of FIG. 15, there are additional challenges to ensure high quality images. These challenges cannot be met by use of the high frequency noise mask described above, because the high frequency dither noise signal of FIG. 17, image (b)(1) does not account for additional visual effects caused by line multiplying.

The dithering operation presents special challenges when line multiplying, partially because it must be performed before line multiplying. Since dithering introduces random noise to an image, dithering of a full height line multiplied image would cause each line of the image to become unique.

Therefore, in implementations where it is desirable to have identical multiplied lines to realize performance advantages, host programs may perform the dithering process at a point in the image pipeline before the line multiplying occurs. However, when an image is dithered before it is line multiplied, the subsequent multiplying operation creates effects in the dithered image. These effects reduce image quality. For example, because line multiplying scales an image in one dimension, it also reduces the frequency of any noise signal along the multiplied dimension of the image by one half.

This lower frequency noise has undesirable visual effects, illustrated by image (e) of FIG. 18. While the non-line multiplied image of image (d) exhibits high image quality as a result of the high frequency noise mask, the line multiplied image of image (e) exhibits reduced visual quality. The lower frequency noise resulting from the multiplying process in the vertical dimension allows the human visual system to perceive quantization errors.

To compensate for the effect of the line doubling on the dithering noise signal, the dither noise signal can be tailored to provide improved results after the line doubling operation occurs. Since the image is multiplied in only one dimension, the dithering may introduce a noise signal with fewer low frequency components in the multiplied dimension, while maintaining frequency components similar to that of the signal represented by the discrete Fourier transform of FIG. 17(b)(2) in the non multiplied dimension. Dithering the reduced height image with a noise signal meeting these characteristics will result in a line multiplied image having an appropriate noise signal in both dimensions. A dither noise signal with such characteristics and its discrete Fourier transform are illustrated by FIG. 17, image (c)(1) and (c)(2). FIG. 17, image (c)(2) illustrates that the noise mask of FIG. 17, image (c)(1) has a two dimensional frequency spectrum that is radially asymmetric around zero frequency. The dark, elliptically shaped portion of image (c)(2) illustrates increased suppression of low frequency components along the vertical dimension of the noise mask represented by image (c)(1) as compared to the horizontal dimension of noise mask (c)(1).

The results of dithering with the noise signal of FIG. 17, image (c)(1) are illustrated in FIG. 18, image (f). Relative to image (e) which was produced with the symmetric high frequency noise signal of FIG. 17, image (b)(1), FIG. 18 image (f) illustrates a reduction in visible effects. This improvement is the result of the high frequency noise that remains in both the horizontal and vertical dimension of the image after the lines have been multiplied. The asymmetric noise signal, while producing an asymmetric noise pattern in the non-multiplied image, results in symmetric high frequency noise in the multiplied image.

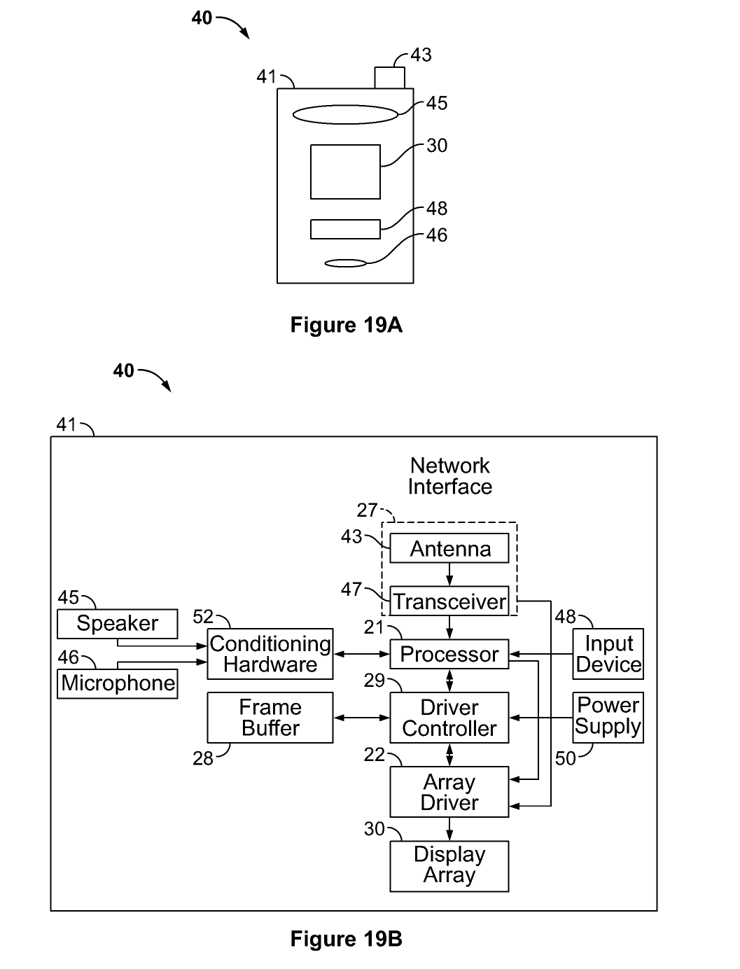

FIGS. 19A and 19B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The illustrated display device 40 can include additional components associated therewith. For example, in one implementation, the display device 40 includes a network interface 27 that includes an antenna 43 which is coupled to a transceiver 47. The transceiver 47 is connected to a processor 56, which is connected to conditioning hardware 52. The conditioning hardware 52 may be configured to condition a signal (e.g. filter a signal). Conditioning hardware 52 generally includes amplifiers and filters for transmitting signals to the speaker 45, and for receiving signals from the microphone 46. Conditioning hardware 52 may be discrete components within the display device 40, or may be incorporated within the processor 56 or other components.

The conditioning hardware 52 is connected to a speaker 45 and a microphone 46. The processor 56 is also connected to an input device 48 and a driver controller 29. A power supply (not shown) provides power to all components as required by the particular display device 40 design. The power supply can include a variety of energy storage devices as are well known in the art. For example, in one implementation, the power supply is a rechargeable battery, such as a nickel-cadmium battery or a lithium ion battery. In another implementation, the power supply is a renewable energy source, a capacitor, or a solar cell, including a plastic solar cell, and solar-cell paint. In another implementation, the power supply is configured to receive power from a wall outlet.

The network interface 27 includes the antenna 43 and the transceiver 47 so that the display device 40 can communicate with one ore more devices over a network. In one implementation the network interface 27 may also have some processing capabilities to relieve requirements of the processor 56. The antenna 43 is any antenna for transmitting and receiving signals. In one implementation, the antenna transmits and receives RF signals according to the IEEE 802.11 standard, including IEEE 802.11(a), (b), or (g). In another implementation, the antenna transmits and receives RF signals according to the BLUETOOTH standard. In the case of a cellular telephone, the antenna is designed to receive CDMA, GSM, AMPS, W-CDMA, or other known signals that are used to communicate within a wireless cell phone network. The transceiver 47 pre-processes the signals received from the antenna 43 so that they may be received by and further manipulated by the processor 56. The transceiver 47 also processes signals received from the processor 56 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A method of displaying an image on an electronic display, comprising:
storing source image data in an electronic memory;
dithering data derived from the source image data using a dither noise signal having a two dimensional frequency spectrum that is radially asymmetric around zero frequency; and
displaying image data derived from the dithered image data on a display.

2. The method of claim 1, further comprising multiplying lines of data derived from the dithered image data.

3. The method of claim 2, wherein the lines are multiplied twice.

4. The method of claim 1, wherein the displayed image data is derived using electronic processing circuitry from a quantized version of the dithered image data.

5. The method of claim 2, wherein the line multiplying and the displaying occur substantially simultaneously.

6. The method of claim 2, wherein the multiplied lines are written substantially concurrently.

7. The method of claim 1, wherein the dithered data is derived from averaged sets of lines of source image data.

8. The method of claim 1, wherein the source image data has a color depth greater than the color depth of the displayed data.

9. The method of claim 1, wherein the frequency spectrum of the dither noise signal has increased suppression of low frequency components along a first dimension of image data to be dithered than along a second dimension of the image data to be dithered.

10. The method of claim 9, wherein the first dimension of the displayed data includes multiplied lines.

11. An apparatus, comprising:
an electronic memory;
an electronic processor, configured to read and write to the electronic memory;
a host program configured to dither data using a dither noise signal having a two dimensional frequency spectrum that is radially asymmetric around zero frequency.

12. The apparatus of claim 11, wherein the host program is further configured to multiply lines derived from the dithered data.

13. The apparatus of claim 12, further comprising a display, wherein the host program is further configured to display the multiplied lines on the display.

14. The apparatus of claim 13, wherein the host program is further configured to quantize data derived from the dithered data.

15. The apparatus of claim 13, wherein the frequency spectrum of the dither noise signal has increased suppression of low frequency components along a first dimension of data to be dithered than along a second dimension of the data to be dithered, and the first dimension of the displayed data includes multiplied lines.

16. The apparatus of claim 12, wherein the host program is configured to multiply the lines by two.

17. A display apparatus comprising a display displaying multiplied lines, wherein the multiplied lines are derived from image data dithered using a dither noise signal with a radially asymmetric frequency spectrum around zero frequency.

18. The display apparatus of claim 17, wherein the multiplied lines have a smaller color resolution than the color resolution of image data.

19. The display apparatus of claim 17, wherein the lines are multiplied twice.

20. The display apparatus of claim 17, further comprising:
a processor that is configured to communicate with the display, the processor being configured to process image data; and
a memory device that is configured to communicate with the processor.

21. The display apparatus of claim 20, further comprising an input device configured to receive input data and to communicate the input data to the processor.

22. A display apparatus comprising:
means for storing source image data in an electronic memory;
means for dithering data derived from the source image data using a dither noise signal having a two dimensional frequency spectrum that is radially asymmetric around zero frequency; and
means for displaying data derived from the dithered data on an electronic display.

23. The display apparatus of claim 22, further comprising means for multiplying lines of data derived from the dithered data.

24. The display apparatus of claim 22, further comprising means for quantizing data derived from the dithered data.

25. A non-transitory, computer readable storage medium having instructions stored thereon that cause a processing circuit to perform a method comprising:
storing source image data to an electronic memory;
dithering data derived from the source image data with a dither noise signal having a two dimensional frequency spectrum that is radially asymmetric around zero frequency; and
displaying data derived from the dithered data on a display.

26. The computer readable storage medium of claim 25, further comprising instructions causing a processing circuit to multiply lines derived from the dithered data.

27. The computer readable storage medium of claim 25, further comprising instructions causing a processing circuit to quantize data derived from the dithered data.
